(19) United States
(12) Patent Application Publication
(10) Pub. No.: US 2012/0253248 A1
(43) Pub. Date: Oct. 4, 2012

(54) Apparatus and System for Manipulating Soft Tissue

(76) Inventor: Thomas G. Carlson, Deer Mountain, UT (US)

(21) Appl. No.: 13/437,424

(22) Filed: Apr. 2, 2012

Related U.S. Application Data
(60) Provisional application No. 61/470,325, filed on Mar. 31, 2011.

(51) Int. Cl. A61H 15/00

(52) U.S. Cl. 601/128

(57) ABSTRACT

An apparatus and system are disclosed for manipulating soft tissue. The apparatus includes a support member, a plurality of substantially circular voids disposed through the support member, and a plurality of spherical members. Each substantially circular void is positioned in alignment with a substantially hemispherical recess having a concave surface defining a spherical member receiving space. Each spherical member is positioned within a spherical member receiving space and is rotatable within one of the spherical member receiving spaces about an infinite number of axes of rotation. Each concave surface of the substantially hemispherical recess is made from a first material and an outer surface of each spherical member is made from a second material. The first material and the second material are selected such that a static coefficient of friction between the first material and second material facilitates rotation of the spherical members within the spherical member receiving spaces.

### CROSS-REFERENCES TO RELATED APPLICATIONS

This application claims the benefit of U.S. Provisional Patent Application No. 61/470,325 entitled “APPARATUS AND SYSTEM FOR MANIPULATING A MUSCLE” and filed on Mar. 31, 2011 for Thomas Carlson, which is incorporated herein by reference.

### FIELD

This subject matter relates to physical therapy, fitness, and self massage and more particularly relates to manual manipulation resulting in strengthening and the elongation of a user's muscles.

### BACKGROUND

Individuals who participate in strenuous physical activity often incur injuries to their muscles and/or nervous system. Often, the injury involves tightening or swelling of the tissue surrounding the nerve (i.e., a “pinched nerve”). The tissue surrounding the nerve is typically, but not always, muscle tissue. A pinched nerve may result from compression, constriction, or stretching of the nerve. Pinched nerves can lead to peripheral neuropathy, mayofascial syndrome, carpal tunnel syndrome, tennis elbow, etc. Pinched nerves can occur anywhere in any soft tissue within an individual's body but a common complaint involves the user's spinal column or back. One treatment for muscle and nerve pain involves massaging the affected area to relax the muscles that may be pinching a nerve. Once the muscles relax, they release the nerve and the user enjoys some relief from the pain.

If the affected individual has a significant other, the significant other may provide the individual with a massage of the affected area. However, the significant other is typically not trained in massage therapy and therefore, the massage given by such an individual may be less than satisfactory or adequate. Accordingly, individuals with moderate to severe pain may be forced to visit a massage therapist or physical therapist to relieve their pain. The cost of receiving a massage can vary with prices ranging from as little as $30.00 per hour to as much as $150.00 per hour or more. Obviously, if the user requires repeat visits to a massage therapist, this form of relief can be cost prohibitive.

### SUMMARY

From the foregoing discussion, it should be apparent that a need exists for an apparatus and system that manipulates a muscle. Beneficially, such an apparatus and system would be adjustable to target specific areas on the user's body and would involve a onetime cost of ownership.

The present invention has been developed in response to the present state of the art, and in particular, in response to the problems and needs in the art that have not yet been fully solved by currently available massaging devices. Accordingly, the present invention has been developed to provide an apparatus and system for manipulating soft tissue that overcome many or all of the above-discussed shortcomings in the art.

The apparatus to manipulate a muscle, in certain embodiments, includes a support member, a plurality of substantially circular voids disposed through the support member, and a plurality of spherical members. Each substantially circular void is positioned in alignment with a substantially hemispherical recess having a concave surface defining a spherical member receiving space. Each spherical member has an outer surface and each spherical member is positioned within a respective spherical member receiving space defined by the substantially hemispherical recesses. Each of the plurality of spherical members is rotatable within one of the spherical member receiving spaces in the plurality of hemispherical recesses about an infinite number of axes of rotation. In certain embodiments, each of the plurality of spherical members rotate independent of one another.

In one embodiment, each concave surface of the substantially hemispherical recess is made from a first material and the outer surface of each spherical member is made from a second material. The first material and the second material are selected such that a static coefficient of friction between the first material and second material facilitates rotation of the spherical members within the spherical member receiving spaces. In one embodiment a membrane covers each of the spherical members. In such an embodiment, the membrane is the second material.

In certain embodiments, a first outer reach plane tangential to an outermost point on a first spherical member in the plurality of spherical members is different from a second outer reach plane tangential to the outermost point on a second spherical member in the plurality of spherical members. The outer most points on the first and second spherical members include points on the first and second spherical members respectively that are the furthest away from the support member.

The support member, in certain embodiments, includes a first end disposed opposite a second end and each of the plurality of spherical members are positioned between the first end and the second end. When the support member is positioned in a horizontal position, an outer reach plane tangential to an outermost point on a spherical member positioned adjacent to one of the first end and the second end is substantially lower than an outer reach plane tangential to an outermost point on a spherical member positioned within a central portion of the support member.

In one aspect of the present subject matter, the support member includes a first end disposed opposite a second end with the plurality of spherical members arranged in a first row, a second row, a third row, a fourth row, and a fifth row across the support member. The first row of spherical members is positioned adjacent to the first end of the support member and the fifth row of spherical members is positioned adjacent to the second end of the support member. The second row of spherical members and the fourth row of spherical members are positioned between the first row of spherical members and the fifth row of spherical members. The third row of spherical members is positioned between the second row of spherical members and the fourth row of spherical members. When the support member is positioned in a horizontal position, an outer reach plane tangential to an outermost point on spherical members positioned in the first row and the fifth row have an outermost reach away from the support member that is substantially lower than an outer reach plane tangential to an outermost point on spherical members positioned in the second row and the fourth row. In certain embodiments, an outer reach plane tangential to an outermost point on spherical members positioned in the second row and fourth row is substantially lower than an outer reach plane tangential to an outermost point on spherical members positioned in the third row.

In another aspect of the present subject matter, the support member includes a first end disposed opposite a second end with the first end and the second end disposed along a common plane. A central portion of the support member is positioned between the first end and the second end, the central portion disposed along a plane offset from the common plane.

In one embodiment, the support member includes an articulated receiving surface contoured to receive a user's back. In certain embodiments, the receiving surface is convex. In other embodiments, the receiving surface is concave.

The apparatus, in certain embodiments, also includes a base member and a plurality of cupping members. The base member supports the plurality of cupping members and each of the cupping members define the substantially hemispherical recess. In another embodiment, the base member includes a plurality of steps with each step supporting at least one of the plurality of cupping members. In yet another embodiment, the plurality of steps includes a first step, a second step, a third step, a fourth step, and a fifth step. In such an embodiment, the first step and the second step are positioned along a first plane, the third step and the fourth step are positioned along a second plane, and the fifth step is positioned along a third plane.

In one aspect of the present subject matter, the plurality of spherical members includes at least two types of spherical members. Each spherical member of a first type of spherical members includes a spherical member made of a material having a first durometer and each spherical member of at least one other type of spherical members includes a spherical member made of a material having a second durometer. In such an embodiment, the first durometer may be a durometer that is less than the second durometer.

In another aspect of the present subject matter, the plurality of spherical members includes at least two types of spherical members. A periphery of each spherical member of a first type of spherical members is larger than a periphery of each spherical member of a second type of spherical members.

In yet another embodiment, the plurality of spherical members comprises at least two types of spherical members with each spherical member of a first type of spherical members interchangeable with a spherical member of at least one other type of spherical members.

The present subject matter also describes an apparatus for manipulating soft tissue that includes a support member, a plurality of substantially circular voids disposed through the support member, and at least two types of spherical members. Each substantially circular void is positioned in alignment with a substantially hemispherical recess having a concave surface defining a spherical member receiving space. Each spherical member of a first type of spherical members includes a spherical member made of a material having a first durometer. Each spherical member of at least one other type of spherical members includes a spherical member made of a material having a second durometer with the first durometer being a durometer that is less than the second durometer. Each spherical member is positioned within a respective spherical member receiving spaces defined by the plurality of substantially hemispherical recesses and each of the plurality of spherical members is rotatable within one of the spherical member receiving spaces in the plurality of hemispherical recesses about an infinite number of axes of rotation.

In certain embodiments, each spherical member of the first type of spherical members is interchangeable with a spherical member of the at least one other type of spherical members. In one embodiment, the support member includes an articulated receiving surface contoured to receive a user's back.

In another embodiment, the apparatus for manipulating soft tissue includes a support member, a plurality of substantially circular voids disposed through the support member, and at least two types of spherical members. Each substantially circular void is positioned in alignment with a substantially hemispherical recess having a concave surface defining a spherical member receiving space. Each spherical member of a first type of spherical members includes a spherical member made of a material having a first durometer. Each spherical member of at least one other type of spherical members includes a spherical member is made of a material having a second durometer with the first durometer being a durometer that is less than the second durometer. In such an embodiment, each spherical member of the first type of spherical members is interchangeable with a spherical member of the at least one other type of spherical members. Each spherical member is positioned within a respective spherical member receiving space and is rotatable within the spherical member receiving space about an infinite number of axes of rotation

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the subject matter will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 depicts a perspective view of one embodiment of an apparatus for manipulating soft tissue in accordance with the present subject matter;

FIG. 2A depicts a side view of one embodiment of an apparatus for manipulating soft tissue in accordance with the present subject matter;

FIG. 2B depicts a side view of one embodiment of an apparatus for manipulating soft tissue in accordance with the present subject matter;

FIG. 3 depicts an end view of one embodiment of an apparatus for manipulating soft tissue in accordance with the present subject matter;

FIG. 4 depicts a top view of one embodiment of an apparatus for manipulating soft tissue in accordance with the present subject matter;

FIG. 5 depicts an exploded side view of one embodiment of an apparatus for manipulating soft tissue in accordance with the present subject matter;

FIG. 6 depicts an exploded cutaway side view taken along line A-A of FIG. 5 illustrating one embodiment of an apparatus for manipulating soft tissue in accordance with the present subject matter;

FIG. 7 depicts a side view of one embodiment of a cupping member containing a spherical member in accordance with the present subject matter;

FIG. 8A depicts a cutaway view of one embodiment of the cupping member and spherical member of FIG. 7 taken along line B-B in accordance with the present subject matter;

FIG. 8B depicts a cutaway view of another embodiment of the cupping member and spherical member of FIG. 7 taken along line B-B in accordance with the present subject matter;

FIG. 9 depicts a perspective view of another embodiment of an apparatus for manipulating soft tissue in accordance with the present subject matter;

FIG. 10 depicts a perspective view of another embodiment of an apparatus for manipulating soft tissue in accordance with the present subject matter; and

FIG. 11 depicts a cutaway view of one embodiment of a spherical member.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

Furthermore, the described features, structures, or characteristics of the subject matter may be combined in any suitable manner in one or more embodiments. In the following description, numerous specific details are provided for a thorough understanding of embodiments of the subject matter. One skilled in the relevant art will recognize, however, that the subject matter may be practiced without one or more of the specific details, or with other methods, components, materials, and so forth. In other instances, well-known structures, materials, or operations are not shown or described in detail to avoid obscuring aspects of the subject matter.

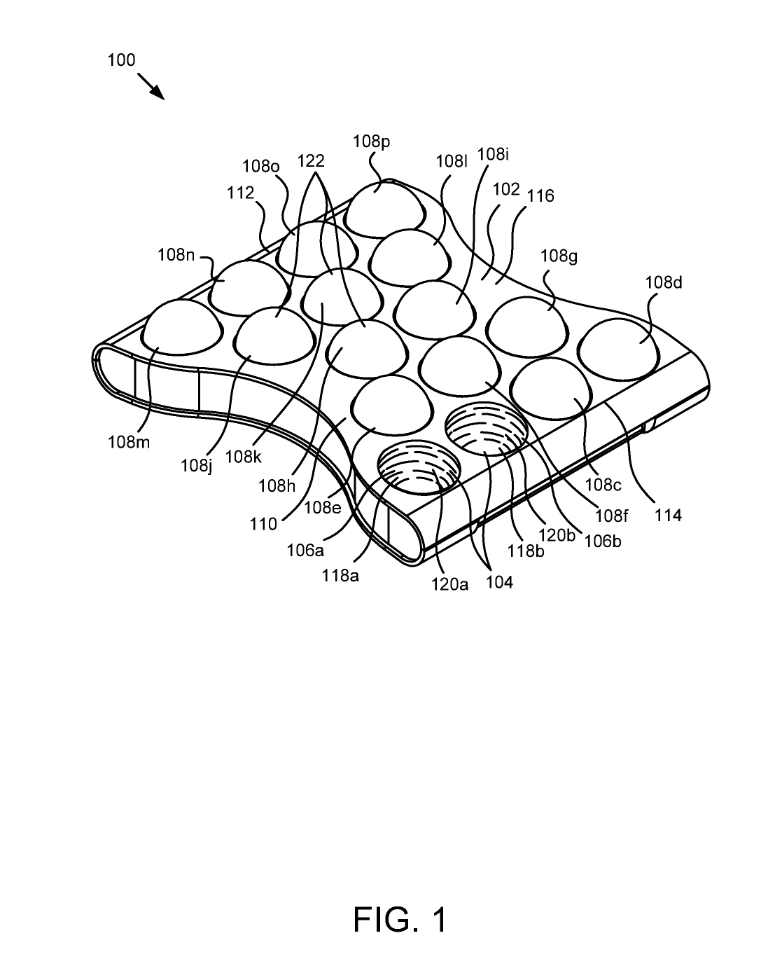

FIG. 1 depicts a perspective view illustrating one embodiment of an apparatus 100 for manipulating soft tissue in accordance with the present subject matter. In certain embodiments, the apparatus 100 includes at least one support member 102, a plurality of substantially circular voids 104 disposed through the at least one support member 102, a plurality of hemispherical recesses 106, and a plurality of spherical members 108.

In one embodiment, the support member 102 is substantially rigid and configured to support a user. The support member 102 may be made of plastic, metal, wood, or any other material having the structural integrity sufficient to support a user (i.e., won't bend or break under the weight of an average human being). As further discussed below, in certain embodiments, the support member 102 includes a receiving surface 110 that is substantially planar. In other embodiments, the receiving surface 110 of the support member 102 may be articulated to contour to the surface of a user's back. In another embodiment, such as embodiments where the apparatus 100 is used to manipulate muscles on other parts of a user's body, i.e., a user's thighs, calves, arms, etc, the receiving surface 110 may be contoured to receive the other parts of the user's body. In such an embodiment, the material comprising the support member 102 may have a structural integrity to support the other parts of the user's body.

The support member 102 includes a first end 112 disposed opposite a second end 114 with a central portion 116 disposed between the first end 112 and the second end 114. A plurality of substantially circular voids 104 are disposed through the support member 102 and align with a plurality of substantially hemispherical recesses 106. Each hemispherical recess 106 has a concave surface 118 that defines a spherical member receiving space 120.

The apparatus 100 also includes a plurality of spherical members 108. Each spherical member 108 is positioned within a respective spherical member receiving space 120 defined by the plurality of substantially hemispherical recesses 106. Each spherical member 108 is rotatable within one of the spherical member receiving spaces 120 in the plurality of hemispherical recesses 106 about an infinite number of axes of rotation. Thus, when force is applied to one of the spherical members 108, the spherical member 108 is able to rotate in any direction. In certain embodiments, the rotation of each spherical member 108 is independent of the rotation of any other spherical member 108.

In certain embodiments, each concave surface 118 of the substantially hemispherical recess 106 is made from a first material. The outer surface 122 of each spherical member 108 is made from a second material. In certain embodiments, the outer surface 122 of the spherical members 108 may be a membrane that covers a core material. In other embodiments, each spherical member 108 is made from a single material such that the outer surface 122 of each spherical member 108 is the same material as the material comprising the core of the spherical member 108.

In one embodiment, the concave surfaces 118 of the substantially hemispherical recesses 106 is made of acrylonitrile butadiene styrene (ABS) plastic and the outer surface 122 of each spherical member 108 is made from polypropylene. In another embodiment, the outer surface 122 of each spherical member 108 may be made from nylon. In such an embodiment, the core (not shown) of the spherical members 108 may be made from a rubberized material to give the spherical members a softer durometer. A softer durometer may facilitate a user's comfort in using the apparatus 100.

In yet another embodiment, the spherical members 108 may be grouped into types of spherical members 108, with one type of spherical members 108 having outer surfaces 122 made of polypropylene and another type of spherical members 108 having outer surfaces 122 made of nylon. One of skill in the art will recognize that other materials may be used on the outer surfaces 122 of the spherical members 108. Further, one of skill in the art will recognize that in certain embodiments, the apparatus 100 may include a multiplicity of types of spherical members 108 with each type of spherical member 108 having a different type of material on the outer surfaces 122 of the spherical members 108.

In one embodiment, the first material (i.e., the material of the concave surfaces 118 of the substantially hemispherical recesses 106) and the second material (i.e., the material of the outer surface 122 of the spherical members 108) are selected such that a static coefficient of friction between the first material and the second material facilitates rotation of each spherical member 108 within each spherical member receiving space 120. One of skill in the art will recognize that the static coefficient of friction of a material is the measure of the sliding resistance of a material over another material when the materials are at rest. The static coefficient of friction between two materials depends on the two materials in question. Therefore, in certain embodiments the first material and the second material are selected such that the static coefficient of friction is minimized to the extent possible while taking into consideration wear characteristics between the first material and the second material. For example, in one embodiment, both the first material and the second material may be polytetrafluoroethylene (PFTE). One of skill in the art will recognize that PFTE has a static coefficient of friction of about 0.05-0.10 which facilitates slippage between the spherical members 108 and the concave surface 118 of the hemispherical recesses 106. In other embodiments, the first material and the second material may be made from other materials having a relatively low static coefficient of friction. Examples of materials having relatively low static coefficient of friction which may be used as the first material and the second material can be found in the CRC Handbook of Physical Quantities by CRC Press which is incorporated herein by reference.

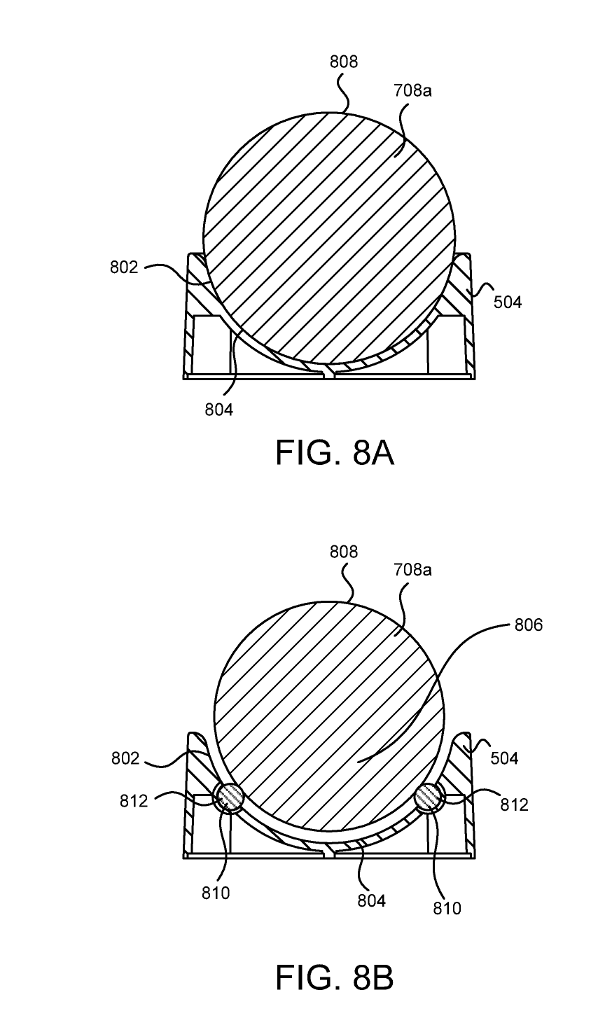

In other embodiments, one or more bearings 810 (FIG. 8B) may be positioned between a spherical member 108 and a respective concave surface 118 of the hemispherical recess 106 to facilitate rotation of the spherical member 108 within the spherical member receiving space 120. One of skill in the art will recognize that in certain embodiments, a low enough static coefficient of friction between the material of the outer surface 122 of the spherical members 108 and the material of the concave surfaces 118 of the substantially hemispherical recesses 106 may make the one or more bearings 810 unnecessary to facilitate rotation of the spherical members 108 within the substantially hemispherical recesses 106.

In use, a user positions a body part on the apparatus 100 and moves the body part with respect to the position of the apparatus 100. As the user moves the body part, the spherical members 108 rotates within the spherical member receiving space 120 allowing the body part to glide across one or more of the spherical members 108. By selecting materials for the outer surface 122 of the spherical members 108 and the concave surface 118 of the hemispherical recesses 106 that have a low static coefficient of friction, the force required to cause the spherical members 108 to rotate within the spherical member receiving space 120 is less that would otherwise be required where these surfaces comprised materials having a relatively high static coefficient of friction.

In certain embodiments, the apparatus 100 may be used on the floor or another substantially flat surface. In such an embodiment, the apparatus 100 is positioned on the floor or other surface and the user lay's on, or otherwise positions a body part on the apparatus 100. The user's bodyweight exerts a downward force on the spherical members 108. The user then moves around on the apparatus 100 to ensure the spherical members 108 contact pressure points or sore spots on the user's back or other body part.

The selection of the materials that make up the spherical members 108 may facilitate a user's comfort when using apparatus 100. For example, spherical members 108 made of materials having a softer or lower durometer will provide a softer contact on the user's pressure points or sore spots on the user's back or other body parts. In certain embodiments, all of the spherical members 108 may be made of a material having a relatively low durometer. In other embodiments, the spherical members 108 may include at least two types of spherical members 108 with each type of spherical member 108 having a different durometer. For example, a spherical member 108 of a first type may be a spherical member 108 made of a material having a first durometer and a spherical member 108 of at least one other type of spherical members 108 may be a spherical member 108 made of a material having a second durometer. In such an embodiment, the first durometer may less than the second durometer. In one embodiment, each type of spherical member 108 may have a different durometer and each spherical member 108 of the first type of spherical members 108 may be interchangeable with a spherical member 108 of at least one other type of spherical members 108.

One of skill in the art will recognize that the spherical members 108 may be interchanged with other spherical members 108 in a group or individually. For example, in one embodiment, all of the spherical members 108 in a particular row or column may be replaced with spherical members 108 of a different type. Alternatively, a particular spherical member 108 may be replaced with a spherical member 108 of a different type having a different durometer. In such an embodiment, if the user has a sore spot or if a particular spherical members 108 (i.e., spherical member 108i) is causing the user pain, the user may replace that particular spherical member 108i with a different type of spherical member 108 having a softer durometer. Alternatively, the user may wish to add pressure to a particular area on the user's body. In this instance, the user can replace corresponding spherical member 108 with a different type of spherical member 108 having a harder durometer.

In one embodiment, the apparatus 100 may be positioned vertically with the receiving surface 110 facing at an angle substantially perpendicular to the ground. In this position a user may place the user's back or other body part against the spherical members 108 and exert as much or as little force to the spherical members 108 as the user finds comfortable. In one embodiment, the apparatus 100 may be incorporated into the back rest of a chair or other seating device. Of course, one of skill will recognize that the apparatus may be positioned at other angles with respect to the ground.

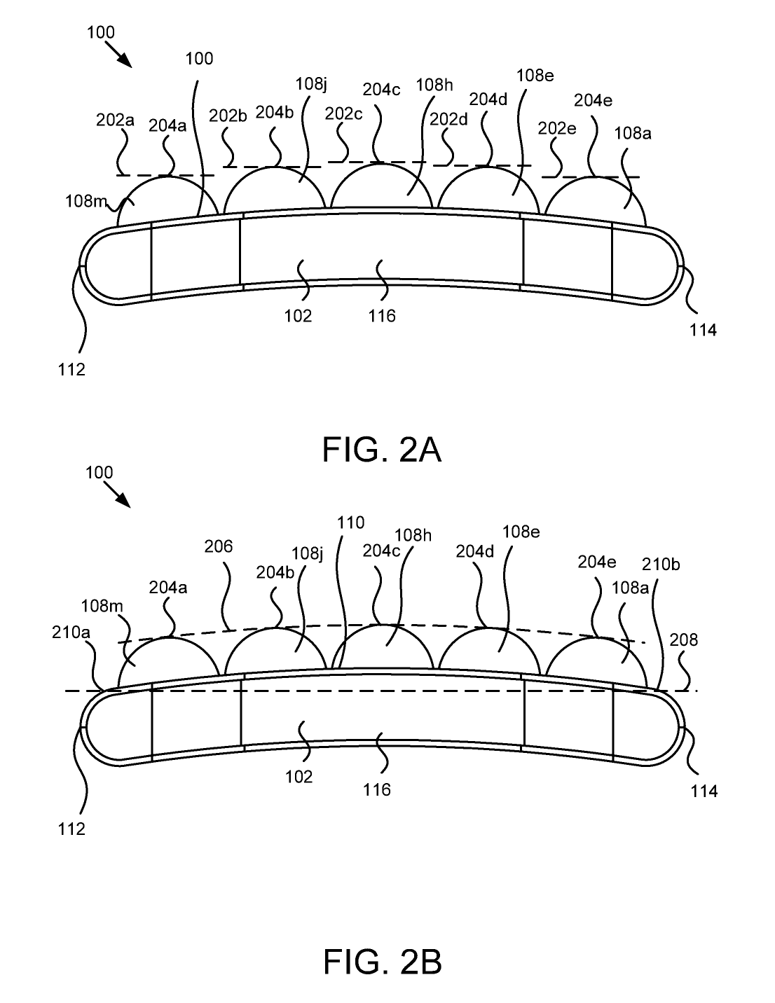

FIG. 2A depicts a side view illustrating one embodiment of an apparatus 100 for manipulating soft tissue in accordance with the present subject matter. In one embodiment, a first outer reach plane 202a tangential to an outermost point 204a on a first spherical member 108m in the plurality of spherical members 108 is different from a second outer reach plane 202b tangential to the outermost point 204b on a second spherical member 108j in the plurality of spherical members 108. The outer most points 202 on the first and second spherical members 108m and 108j respectively are points on the first and second spherical members 108m and 108j that are the furthest away from the support member 102. Thus, in the embodiment illustrated in FIG. 2, the second outermost point 204b on the second spherical member 108j is substantially higher than the first outermost point 204a on the first spherical member 108m when the apparatus 100 is positioned in a horizontal position.

Similarly, in one embodiment, an third outer reach plane 202c tangential to a third outermost point 204c on a third spherical member 108h may be substantially higher than the first and second outer reach planes 202a and 202b tangential to the outermost points 204a and 204b on the first and second spherical members 108m and 108j respectively when the apparatus 100 is positioned in a horizontal position.

A fourth outer reach plane 202d tangential to a fourth outermost point 204d on a fourth spherical member 108e may be substantially lower than the third outer reach plane 202c tangential to the third outermost point 204c on the third spherical member 108h. Similarly, a fifth outer reach plane 202e tangential to a fifth outermost point 204e on a fifth spherical member 108a may be substantially lower than the fourth outer reach plane 202d tangential to the fourth outermost point 204d on the fourth spherical member 108e.

In certain embodiments, the first spherical member 108m and the fifth spherical member 108a are positioned adjacent to the first end 112 and the second end 114 respectively. The second spherical member 108j and the fourth spherical member 108e are positioned between the first spherical member 108m and the fifth spherical member 108a. The third spherical member 108h is positioned between the second spherical member 108j and the fourth spherical member 108e.

In certain embodiments the first outer reach plane 202a and the fifth outer reach plane 202e are positioned at substantially the same height when the apparatus 100 is positioned in a horizontal position. Similarly, in one embodiment, the second outer reach plane 202b and the fourth outer reach plane 202d are positioned at substantially the same height when the apparatus 100 is positioned in a horizontal position. The third outer reach plane 202c, in one embodiment, is substantially higher than the first outer reach plane 202a, the second outer reach plane 202b, the fourth outer reach plane 202d, and the fifth outer reach plane 202e. Accordingly, in one embodiment, spherical members 108 positioned in the central portion 116 of the apparatus 100 have outermost points 204 that are substantially higher than the outermost points of spherical members 108 positioned closer to the first or second ends 112, 114 of the apparatus 100. In certain embodiments, the outermost points 204 of each spherical member 108 is positioned along an imaginary line 206 that is substantially convex as depicted in FIG. 2B.

In other embodiments, the outermost points 204 of each spherical member 108 may be positioned along an imaginary line 206 that is substantially concave. That is, in one embodiment the third outermost point 204c of the third spherical member 108h may be positioned substantially lower than the second outermost point 204b and the fourth outermost point 204d of the second and fourth spherical member 108j and 108e respectively with the apparatus 100 positioned in a horizontal position. In such an embodiment, the first outermost point 202a and the fifth outermost point 202e may be positioned substantially lower than the second and fourth spherical member 108j and 108e respectively such that the imaginary line 206 connecting each outermost point 204 is substantially concave.

In another embodiment, the outermost points 204 of each spherical member 108 may be positioned at a repeating height that causes the imaginary line 206 to undulate in a repeating pattern. For example, in one embodiment, the first outermost point 204a of the first spherical member 108m and the fifth outermost point 204e of the fifth spherical member 108a may be positioned at a first height with the apparatus 100 positioned in a horizontal position. The second outermost point 204b of the second spherical member 108j and the fourth outermost point 204d of the fourth spherical member 108e may be positioned at a second height with the apparatus 100 positioned in a horizontal position that is substantially lower than the first height. The third outermost point 204c of the third spherical member 108h may be positioned at a third height with the apparatus 100 positioned in a horizontal position that is substantially higher than the second height. In one embodiment, the first height and the third height may be substantially equal. In other embodiments, each of the first, second, and third height may be different. In yet another embodiment, each outermost point 204 may be positioned along the same plane.

Reference herein to the central portion 116 of the support member 102 may be defined, in one embodiment, as referring to the portion of the apparatus disposed between the first end 112 and the second end 114 of the support member 102. Thus, in certain embodiments, each spherical member 108 is positioned in the central portion 116 of the support member 102. In other embodiments, the central portion 116 of the support member 102 may be the portion of the support member 102 that lies between the first spherical member 108m and the fifth spherical member 108a.

FIG. 2B depicts a side view illustrating one embodiment of an apparatus 100 for manipulating soft tissue in accordance with the present subject matter. As discussed above, in certain embodiments, the receiving surface 110 of the support member 102 may be contoured to receive a user's back. For example, in one embodiment, the areas 210a and 210b of the receiving surface 110 near the first end 112 and the second end 114 of the support member 102 are disposed along a common plane 208 and an area 212 of the receiving surface 110 near the central portion 116 of the support member 102 is disposed along a plane offset from the common plane 208. In one embodiment the receiving surface 110 of the support member 102 is substantially convex. In other embodiments, the receiving surface 110 of the support member 102 is concave. In yet another embodiment, the receiving surface 110 of the support member 102 may be substantially planar.

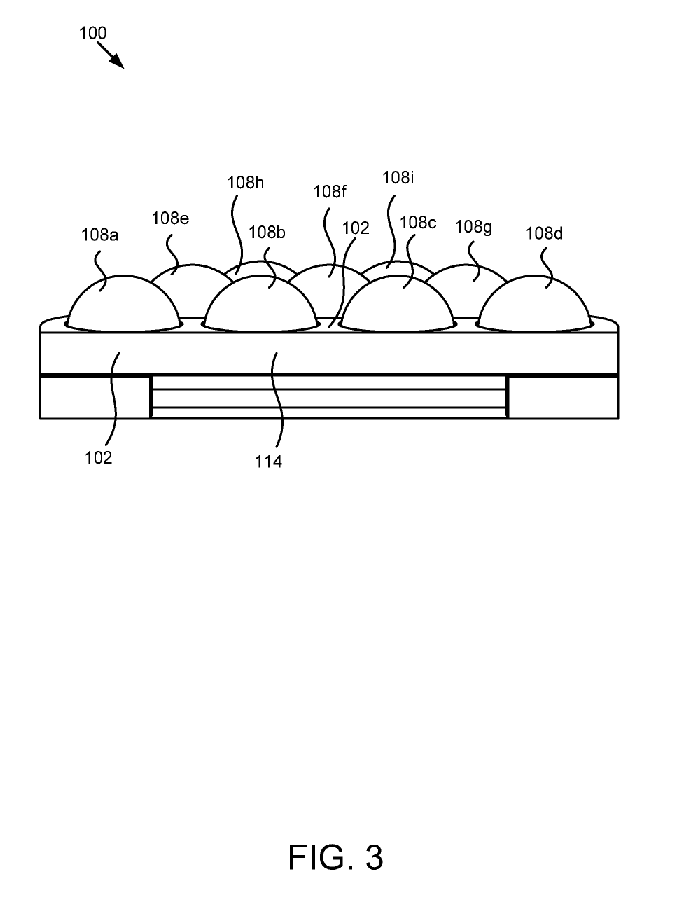

FIG. 3 depicts an end view illustrating one embodiment of an apparatus 100 for manipulating soft tissue in accordance with the present subject matter. In certain embodiments, the first end 112 and the second end 114 of the support member 102 are substantially planar such that the support member 102 is either convex or concave in a single dimension. In other embodiments the first end 112 and the second end 114 of the support member 102 may be concave or convex such that the support member 102 is either convex or concave such that the support member 102 is convex or concave in two dimensions (i.e., spoon shaped).

In the embodiment illustrated in FIG. 3, the spherical members 108 are arranged in a series of rows across the support member 102. In certain embodiments, each spherical member 108 in a particular row is positioned at substantially the same height as all other spherical members 108 in that particular row when the apparatus 100 is positioned in a horizontal position. In other embodiments, the spherical members 108 in a particular row may be positioned such that the outermost points 204 (FIG. 2A) of each spherical member 108 in that particular row are arranged in a concave or convex array.

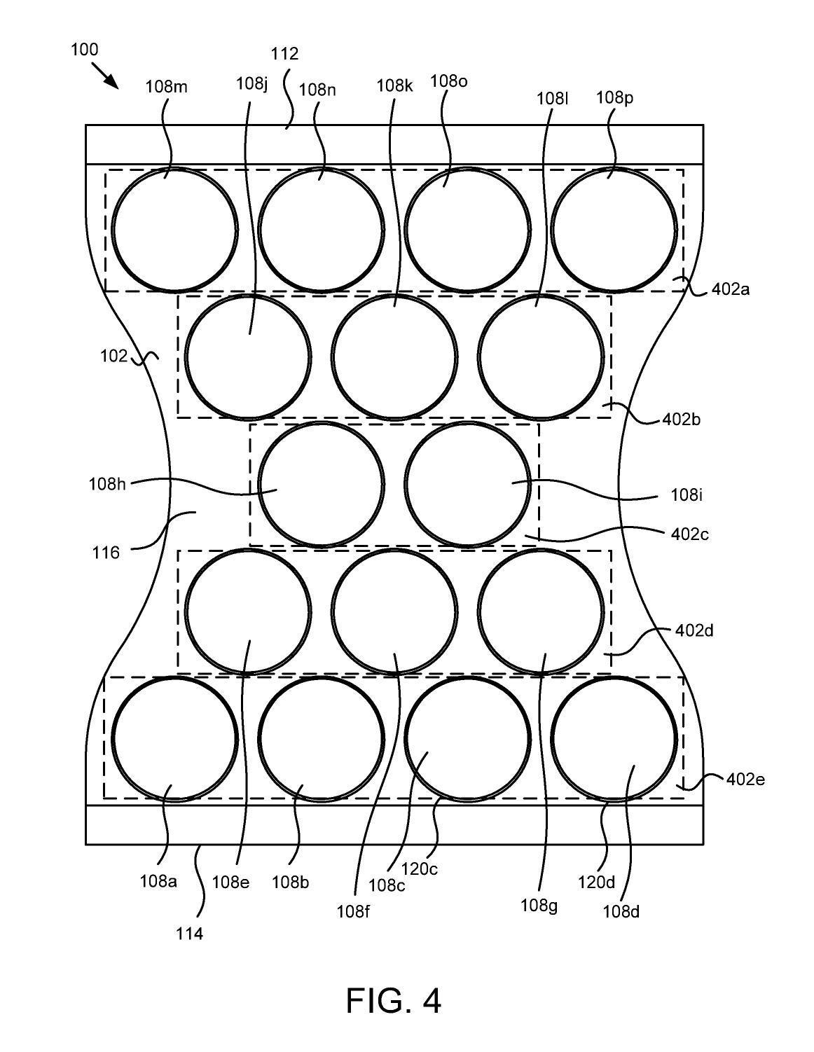

FIG. 4 depicts a top view illustrating one embodiment of an apparatus 100 for manipulating soft tissue in accordance with the present subject matter. For clarity, in the embodiment illustrated in FIG. 1, receiving spaces 120c and 120d are depicted without spherical members 108. In the embodiment illustrated in FIG. 2A-4, spherical members 108c and 108d are depicted as being positioned within receiving spaces 120c and 120d.

In one embodiment, the spherical members 108 are arranged in rows across the support member 102. In the embodiment illustrated in FIG. 2, spherical members 108m-108p are positioned in a first row 402a, spherical members 108j-108l are positioned in a second row 402b, spherical members 108h and 108i are positioned in a third row 402c, spherical members 108e-108g are positioned in a fourth row 402d, and spherical members 108a-108d are positioned in a fifth row 402e.

Spherical members 108m-108p located in the first row 402a are positioned adjacent to the first end 112 of the support member 102. Spherical members 108a-108d located in the fifth row 402e are positioned adjacent to the second end 114 of the support member 102. The spherical member's 108j-108l located in the second row 402b and the spherical members 108e-108g located in the fourth row 402d are positioned between the spherical members 108 in the first row 402a and the fifth row 402e. Spherical members 108h and 108i located in the third row 402c are positioned between the spherical members 108 located in the second row 402b and fourth row 402d.

In certain embodiments, when the support member 102 is positioned in a horizontal position, the outer reach plane 202 tangential the outermost points 204 on spherical members 108 located in the first row 402a and the fifth row 402e have an outermost reach away from the support member 102 that is substantially lower than an outer reach plane 202 tangential to outermost points 204 on spherical members 108 positioned in the second row 402b and the fourth row 402d. Similarly, in one embodiment, the outer reach planes 202 tangential to outermost points 204 on spherical members 108 positioned in the second row 402b and the fourth row 402d is substantially lower than the outer reach planes 202 tangential to outermost points 204 on spherical members 108 positioned in the third row 402c. Thus, in one embodiment, the outermost points 204 on each spherical member 108 form a substantially convex array of points. In other embodiments, the array of outermost points 204 on the spherical members 108 may be substantially concave. In yet another embodiment, the array of outermost points 204 on the spherical members 108 may be substantially planar. One of skill in the art will recognize that the array of outermost points 204 on the spherical members 108 may be arranged in other geometric shapes.

In certain embodiments, the spherical members 108 in each row are offset such that a spherical member 108 is positioned substantially half way between two adjacent spherical members. For example, in the embodiment illustrated in FIG. 4 spherical member 108g is positioned half way between spherical members 108c and 108d. In other embodiments, the spherical members 108 may be aligned in rows 402 as well as columns.

In the embodiment illustrated in FIG. 4, the support member 102 is substantially hourglass shaped and the spherical members 108 conform to the hourglass shape. For example, in the embodiment illustrated in FIG. 4 the first row 402a includes four spherical members 108. The second row 402b includes three spherical members 108 and the third row includes two spherical members 108. The fourth row 402d includes three spherical members 108 and the fifth row includes four spherical members 108. In use, when a user positions a body part on the apparatus 100, the user may feel an increased pressure with reference to spherical members 108h and 108i as there are fewer spherical members 108 located in the third row 402c to distribute the user's weight. The increased pressure on spherical members 108h and 108i may also be the result of the fact that in certain embodiments the outermost points 204 of these two spherical members 108h and 108i are positioned at a higher position than the outermost points 204 of spherical members 108 located in the first row 402a, the second row 402b, the fourth row 402d, and the fifth row 402e when the apparatus is positioned in a horizontal position.

In one embodiment, the user may use the increased pressure provided by the spherical members 108h and 108i located in the third row 402c to specifically work out or relieve sore spots on the user's body part. An hourglass shaped support member 102 with corresponding spherical members 108, in one embodiment, allows a user to focus pressure on the two spherical members 108h and 108i located in the center row (the third row 402c) of the support member 102. In other embodiments, the support member 102 is square, rectangular, circular, or any other geometric shape and may have an equal number of spherical members 108 in each row. One of skill in the art will recognize that it is within the scope of the present disclosure to vary the amount of spherical members 108 located within each row 402.

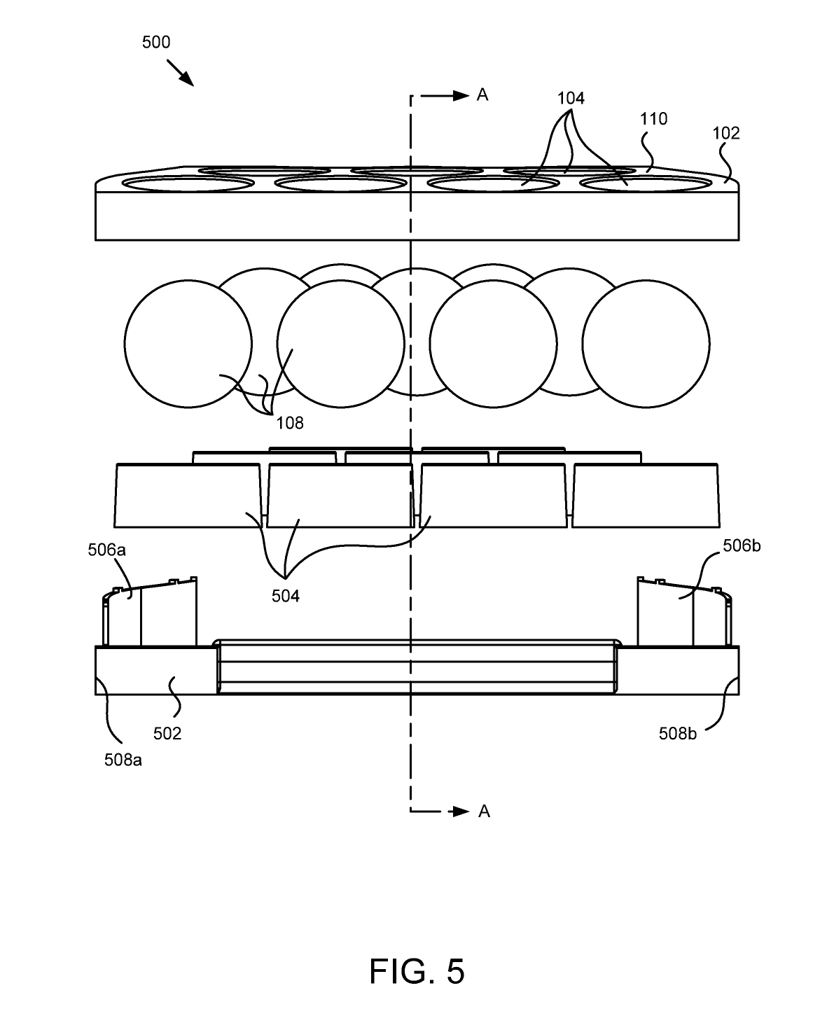

FIG. 5 depicts an exploded side view illustrating one embodiment of an apparatus 500 for manipulating soft tissue in accordance with the present subject matter. In certain embodiments, the apparatus 500 includes a support member 102, a plurality of substantially circular voids 104 disposed through the at least one support member 102, a plurality of spherical members 108, a base member 502, and a plurality of cupping members 504.

In certain embodiments, the support member 102 includes a receiving surface 110 for receiving a user's body part such as a user's back. The support member 102, in certain embodiments, may be substantially planar. In other embodiments, the support member 102 may be concave or convex as discussed above.

In one embodiment, a base member 502 is positioned opposite the support member 102. The base member 502, in certain embodiments, supports the apparatus 500 on the ground or other surface upon which the apparatus 500 is placed.

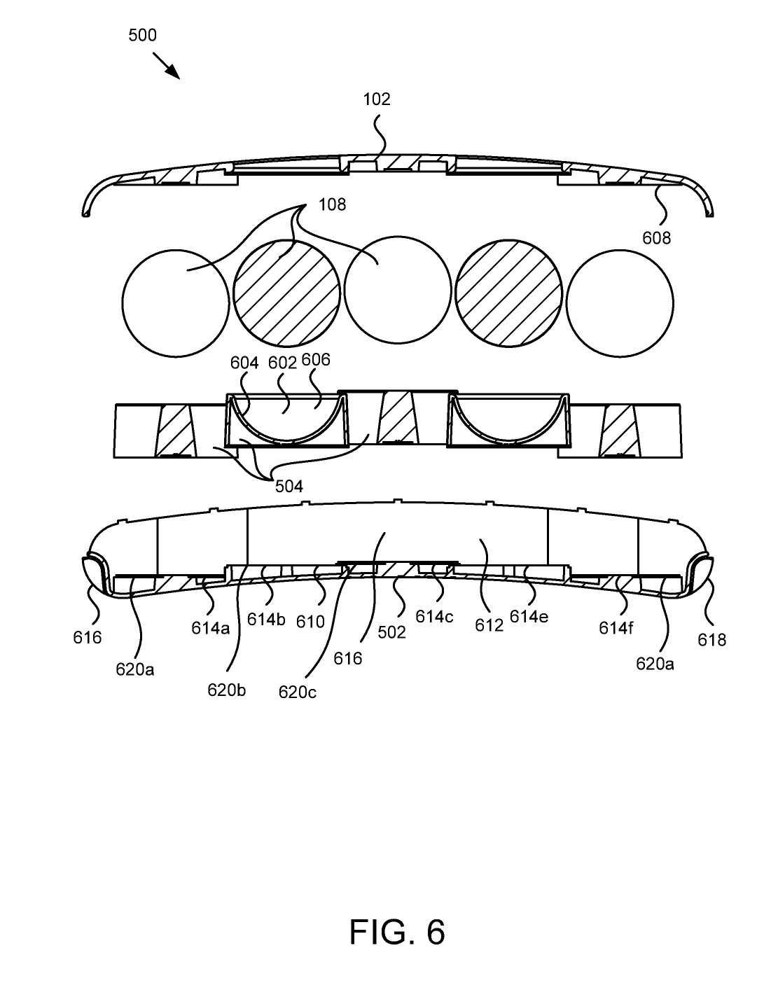

A plurality of cupping members 504 are positioned between the support member 102 and the base member 502. With reference to FIG. 6, in certain embodiments, each cupping member 504 includes a hemispherical recess 602 having a concave inner surface 604 that defines the spherical member receiving space 606.

A plurality of substantially circular voids 104 are disposed through the at least one support member 102. In one embodiment, each substantially circular void 104 aligns with the hemispherical recesses 602 in the cupping members 504 such that at least a portion of the spherical members 108 extend through the substantially circular voids 104 in the support member 102 when the spherical member 108 is positioned within the spherical member receiving space 606.

In one embodiment, the diameter of each substantially circular void 104 is substantially smaller than the diameter of each spherical member 108 at its largest point. In such an embodiment, the spherical members 108 are positioned within the spherical member receiving space 606 in each cupping member 504 and the base member 502 is coupled to the support member 102 to effectively lock each spherical member 108 within a spherical member receiving space 606. The coupling between the base member 502 and the support member 102 may be done with one or more mechanical fasteners, a snap fit connection, or a chemical adhesive as is known in the art. Because the diameter of each substantially circular void 104 is substantially smaller than the diameter of each spherical member 108 at its largest point, each spherical member 108 is retained within its respective spherical member receiving space 606 when the base member 502 is coupled to the support member 102.

In embodiments where the spherical members 108 are interchangeable, the support member 102 may be removably coupled to the base member 502 to allow a user access to the cupping members 504 to interchange the spherical members 108. In one embodiment, the support member 102 may be coupled to the base member 502 by a hinge at one end of the support member 102 and may be removably coupled to the base member 502 at the other end. In such an embodiment, the support member 102 swings away from the base member 502 about the hinge (not shown) to provide access to the cupping members 504. When the unhinged end of the support member 102 is coupled to the unhinged end of the base member 502, the support member 102 locks the spherical members 108 in place within the cupping members 504. One of skill in the art will recognize that the coupling between the base member 502 and the support member 102 should be sufficient to keep the spherical members 108 positioned within the cupping members 504 but should not be so tight as to inhibit rotation of the spherical members 108 within the cupping members 504.

In certain embodiments, the base member 502 includes a set of guiding flanges 506a and 506b extending perpendicularly from each side 508a and 508b of the base member 502 in a direction of the support member 102. The guiding flanges 506a and 506b are contoured to align with a coupling surface 608 (FIG. 6) of the support member 102 when the base member 502 and the support member 102 are coupled to one another. The guiding flanges 506a and 506b prevent lateral movement of the support member 102 with respect to the base member 502. In certain embodiments, the guiding flanges 506a and 506b also ensure that the cupping members 504 remain positioned within a cupping member receiving space 612 defined by a cupping member receiving surface 610 (FIG. 6) of the base member 502, the coupling surface 608 (FIG. 6) of the support member 102, and the flanges 506a and 506b, when the base member 502 is coupled to the support member 102.

In certain embodiments, a vibrating member (not shown) may be coupled to at least one of the base member 502, the plurality of cupping members 504, and/or the support member 102. In one embodiment, the vibrating member may be configured to impart a vibratory motion to the spherical members 108 to massage a body part of a user. In other embodiments, the vibrating member may be configured to impart a vibratory motion to the support member 102 such that only the support member 102 vibrates. In yet another embodiment, the vibrating member may be configured to impart a vibratory motion to the base member 502 such that the entire apparatus 500 vibrates when the base member is positioned on a support surface.

FIG. 6 depicts an exploded cutaway side view taken along line A-A of FIG. 5 illustrating one embodiment of an apparatus 500 for manipulating soft tissue in accordance with the present subject matter. In certain embodiments, the cupping member receiving surface 610 of the base member 502 includes a plurality of steps 614. Each step 614 supports at least one of the cupping members 504.

In one embodiment, the steps 614 are arranged such that a cupping member 504 positioned within a central portion 616 of the base member 502 is substantially higher than a cupping member 504 positioned closer to an first end 616 or a second end 618 of the base member 502 when the base member 502 is positioned in a horizontal position. For example, in certain embodiments, the plurality of steps 614 includes a first step 614a, a second step 614b, a third step 614c, a fourth step 614d, and a fifth step 614e. The first step 614a and the fifth step 614e are positioned along a first plane 620a such that a cupping member 504 positioned on the first step 614a is at substantially the same height as a cupping member 504 positioned on the fifth step 614e when the base member 502 is positioned in a horizontal position. Similarly, the second step 614b and the fourth step 614d are positioned along a second plane 620b such that a cupping member 504 positioned on the second step 614b is at substantially the same height as a cupping member 504 positioned on the fifth step 614d when the base member 502 is positioned in a horizontal position. The third step 614c is positioned along a third plane 620c which is at a different height than the first plane 620a or second plane 620b when the base member 502 is positioned in a horizontal position.

In certain embodiments, the first plane 620a, the second plane 620b, and the third plane 620c may be at heights that cause the outermost points 204 on the spherical members 108 to be arranged in a substantially convex array of points when the apparatus 500 is fully assembled. In other embodiments, the first plane 620a, the second plane 620b, and the third plane 620c may be at heights that cause the outermost points 204 on the spherical members 108 to be arranged in a substantially concave array of points when the apparatus 500 is fully assembled. That is, in one embodiment, the third plane 620c may be positioned substantially lower than the second plane 620b which, in turn, may be substantially lower than the first plane 620a when the base member 502 is positioned in a horizontal position.

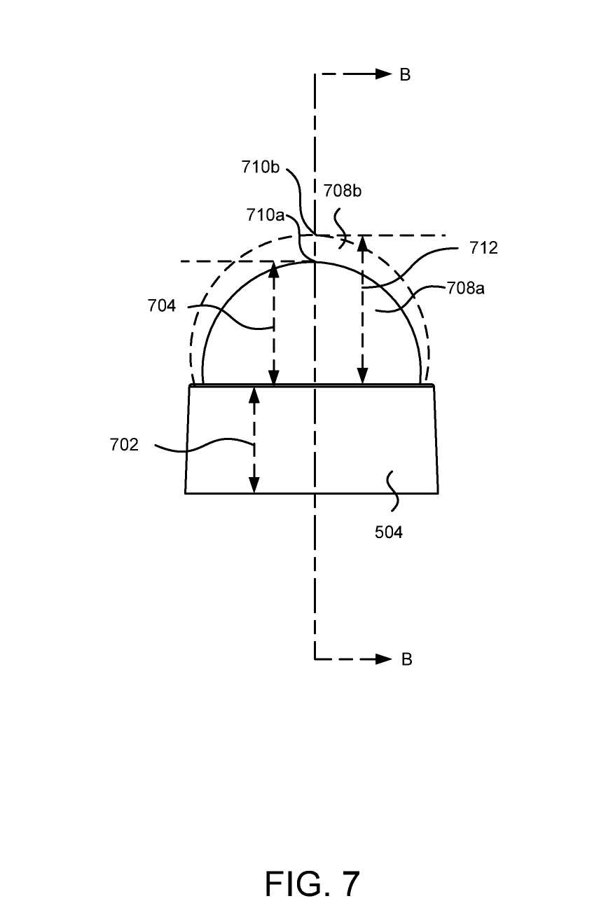

FIG. 7 depicts a side view illustrating one embodiment of a cupping member 504 containing a spherical member 708a in accordance with the present subject matter. For the purpose of the present discussion, a second spherical member 708b is shown in phantom line. In certain embodiments, the spherical members 708a and 708b may be substantially similar to the spherical members 108 described above.

In certain embodiments, each of the plurality cupping members 504 are substantially the same size and each of the plurality of spherical members 708 are substantially the same size. In other embodiments, the size of the cupping members 504 and/or the spherical members 708 may be varied to alter the position of an outermost point 710 on a particular spherical member 708. For example, if a depth 702 of the cupping member 504 is held constant, an outermost point 710a on the spherical member 708a will be positioned a first distance 704 away from the cupping member 504. If a larger spherical member 708b is positioned within the cupping member 504 and the depth 702 of the cupping member 504 remains the same, an outermost point 710b will be positioned a second distance 712 away from the cupping member 504. One of skill in the art will recognize that in such an embodiment, the second distance 712 will be substantially larger than the first distance. Thus, in certain embodiments, the size of the spherical members 108 may be varied to form a convex or concave array of outermost points 710.

In one embodiment, the spherical members 708 include at least two types of spherical members 708 with a first type of spherical member 708 having an outer periphery that is larger than an outer periphery of spherical members 708 of a second type. For example, in certain embodiments, the first type of spherical member 708 may be a spherical member 708 such as spherical member 708b and the second type of spherical member 708 may be a spherical member 708 such as spherical member 708a. In certain embodiments, each spherical member 708 of a first type of spherical members 708b may interchangeable with a spherical member 708 of at least one other type of spherical members 708. By changing the size of a particular spherical member 708, the user can increase or decrease the pressure applied to a particular area on the user's body. For example, a spherical member 708 having a larger periphery than spherical members 708 adjacent to that spherical member 708 will place a relatively larger amount of pressure on the area of the user's body that comes in contact with that spherical member 708. Of course, the converse is also true, a spherical member 708 having a smaller periphery than spherical members 708 adjacent to that spherical member 708 will place a relatively smaller amount of pressure on the area of the user's body that comes in contact with that spherical member 708.

FIG. 8A depicts a cutaway view of one embodiment of the cupping member 504 and spherical member 708a of FIG. 7 taken along line B-B in accordance with the present subject matter. In the embodiment illustrated in FIG. 8A the larger spherical member 708b has been removed for clarity. In certain embodiments, the cupping member 504 includes a substantially hemispherical recess 802 that has a concave surface 804 that defines a spherical member receiving space 806. The spherical member 708a is positioned within the spherical member receiving space 802 in the cupping member 504 and the portion of the outer surface 808 that is positioned within the spherical member receiving space 802 is continuous with the concave surface 804 of the hemispherical recess 802.

In certain embodiments the material that makes up the outer surface 808 of the spherical member 708a and the material that makes up the concave surface 804 of the hemispherical recess 802 are selected such that a static coefficient of friction is minimized as discussed above. By manufacturing the outer surface 808 of the spherical member 708a and the concave surface 804 of the hemispherical recess 802 with materials having a relatively low coefficient of friction, the spherical member 708a can freely rotate within the cupping member 504.

FIG. 8B depicts a cutaway view of another embodiment of the cupping member 504 and spherical member 708a of FIG. 7 taken along line B-B in accordance with the present subject matter. As with FIG. 8A, in FIG. 8B the larger spherical member 708b has been removed for clarity. In certain embodiments, one or more bearings 810 are positioned within bearing recesses 812 formed in the concave surface 804 of the hemispherical recess 802. In such an embodiment, the bearings 810 facilitate rotation of the spherical member 708a within the spherical member receiving space 806.

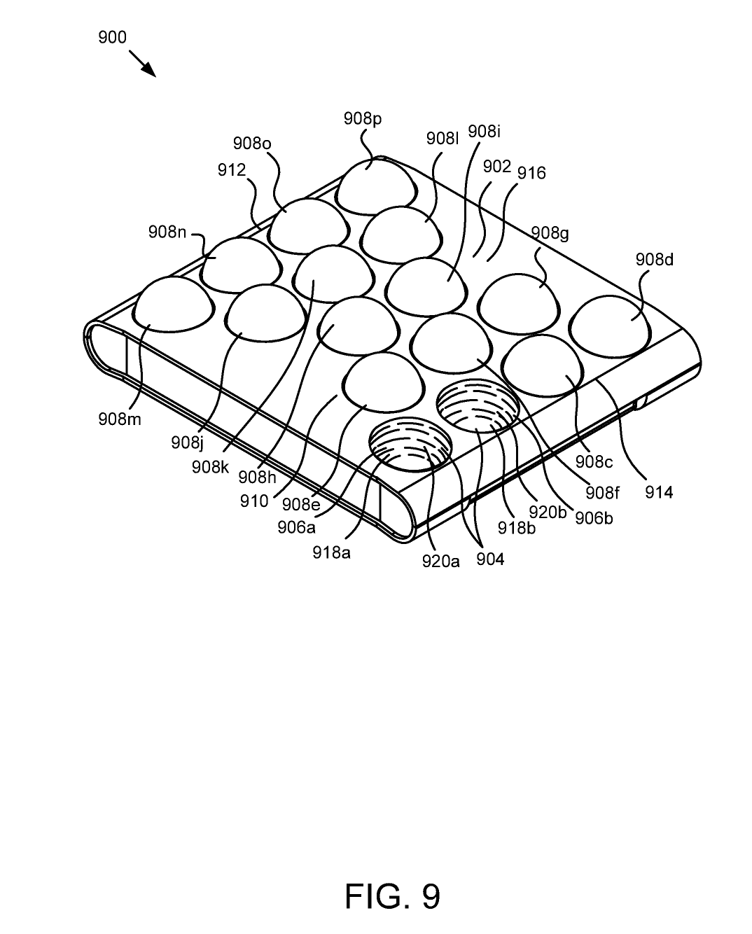

FIG. 9 depicts a perspective view illustrating another embodiment of an apparatus 900 for manipulating soft tissue in accordance with the present subject matter. In certain embodiments, the apparatus 900 includes at least one support member 902, a plurality of substantially circular voids 904 disposed through the at least one support member 902, a plurality of hemispherical recesses 906, and a plurality of spherical members 908.

In one embodiment, the support member 902 is substantially rigid and configured to support a user. The support member 902 may be made of plastic, metal, wood, or any other material having the structural integrity sufficient to support a user (i.e., won't bend or break under the weight of an average human being). In the embodiment illustrated in FIG. 9, the support member 902 includes a receiving surface 110 that is substantially planar. In other embodiments, as discussed above, the receiving surface 910 of the support member 902 may be articulated to contour to the surface of a user's back. In another embodiment, such as embodiments where the apparatus 900 is used to manipulate muscles on other parts of a user's body, i.e., a user's thighs, calves, arms, etc, the receiving surface 910 may be contoured to receive the other parts of the user's body. In such an embodiment, the material comprising the support member 902 may have a structural integrity to support the other parts of the user's body.

The support member 902 includes a first end 912 disposed opposite a second end 914 with a central portion 916 disposed between the first end 912 and the second end 914. In the embodiment illustrated in FIG. 9, the support member 902 is substantially rectangular. In other embodiments, the support member 902 may be square, circular, hourglass shaped, or any other geometric shape.

A plurality of substantially circular voids 904 are disposed through the support member 902 and align with a plurality of substantially hemispherical recesses 906. Each hemispherical recess 906 has a concave surface 918 that defines a spherical member receiving space 920. In one embodiment, such as in embodiments where the spherical members 908 are made of a relatively soft material (i.e., a material having a relatively low durometer), the circular voids 904 and the concave surfaces 918 that define the spherical member receiving spaces 920, maintain the substantially spherical shape of the spherical members 908. For example, if pressure is applied to a spherical member 908 that is made of a relatively soft material, the characteristics of the relatively soft spherical member 908 would cause that spherical member to deform. However, because the spherical member 908 is positioned within the spherical member receiving space 920, the concave surface 918 of the spherical member receiving space 920 cradles the soft spherical member 908 and keeps it in a substantially spherical shape.

Each spherical member 908 is positioned within a respective spherical member receiving space 920 defined by the plurality of substantially hemispherical recesses 906. Each spherical member 908 is rotatable within one of the spherical member receiving spaces 920 in the plurality of hemispherical recesses 906 about an infinite number of axes of rotation. Thus, when force is applied to one of the spherical members 908, the spherical member 908 is able to rotate in any direction. In certain embodiments, the rotation of each spherical member 908 is independent of the rotation of any other spherical member 908.

As discussed above, in certain embodiments, the spherical members 908 may be selected from one or more types of spherical members 908. For example, in certain embodiments, a first type of spherical members 908 may include spherical members 908 made of a material having a specific durometer and a second type of spherical members 908 may include spherical members 908 made of a material having a different durometer than the durometer of the material of the first type of spherical members 908. In such an embodiment, each spherical member 908 of the first type of spherical members 908 may be interchangeable with at least one other type of spherical members 908.

In one embodiment, the spherical members 908 may be interchangeable with other types of spherical members 908 by row or column. For example, in one embodiment, the spherical members 908 that are positioned in the row of spherical members 908 nearest the first end 912 of the support member 902 (i.e., spherical members 908m-908p) may be interchangeable with a specific type of spherical member 908. In such an embodiment, the spherical members 908 positioned in the next row (i.e., spherical members 908j-908l) may only be interchangeable with a type of spherical member 908 that is different than the type of spherical member that is interchangeable with the row of spherical members 908 nearest the first end 912 of the support member 902.

In other embodiments, any spherical member 908 may be interchangeable with any type of spherical member 908. By incorporating interchangeable spherical members 908, the apparatus 900 allows a user to customize the apparatus to work on specific areas of the user's body. For example, if the user has a sore pressure point on the user's spine, the user may wish to replace the center row of spherical members (i.e., spherical members 908h and 908i) with a type of spherical member 908 that has a softer durometer.

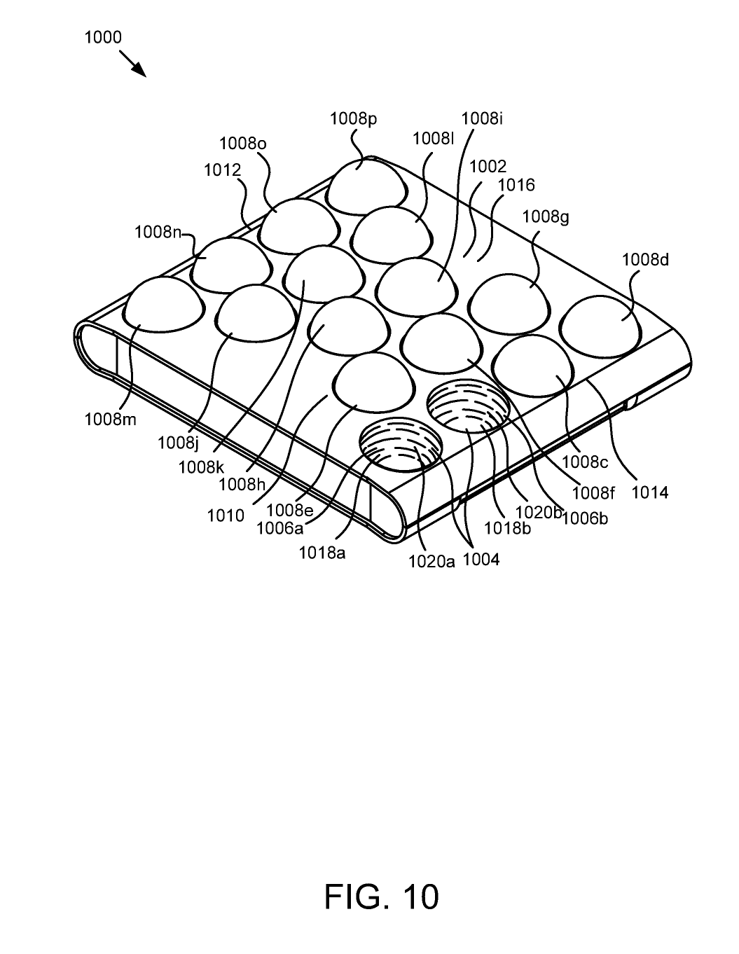

FIG. 10 depicts a perspective view illustrating another embodiment of an apparatus 1000 for manipulating soft tissue in accordance with the present subject matter. In certain embodiments, the apparatus 900 includes at least one support member 902, a plurality of substantially circular voids 904 disposed through the at least one support member 902, a plurality of hemispherical recesses 906, and a plurality of spherical members 908.

In certain embodiments, the apparatus 1000 of FIG. 10 may be substantially similar to the apparatus 900 of FIG. 9 except that the spherical members 1008 may be permanently positioned within a respective spherical member receiving space 1020 as defined by the concave surface 1018 of the hemispherical recesses 1006. In such an embodiment, the spherical members 1008 may still include a number of spherical member types. For example, the spherical members 1008 in the row closes the first end 1012 of the apparatus 1000 (i.e., spherical members 1008m-1008p) may include spherical members 1008 of a first type of spherical members 1008. Spherical members 1008 in the next row (i.e., spherical member's 1008j-1008l) may include spherical members 1008 of a second type. The next row of spherical members 1008 (i.e., spherical members 1008h and 1008i) may include spherical members 1008 of a third type. In one embodiment, spherical members in the fourth row (i.e., spherical member's 1008e-1008g) and the fifth row (i.e., spherical member's 1008c and 1008d) may each include different spherical member types. In another embodiment, the spherical members 1008 in the fifth row may be of the same type as the spherical members 1008 in the first row and the spherical members 1008 in the fourth row may be of the same type as the spherical members 1008 in the second row.

In certain embodiments, the spherical member types may be classified by the durometer of the material that the spherical members 1008 are made of. For example, in one embodiment, spherical members 1008 in the first row and the fifth row may be made of a material having a harder durometer than the spherical members 1008 in the second row and fourth row. Similarly, the spherical members 1008 in the second and fourth row may be made of a material having a harder durometer than the spherical members 1008 in the third row (the middle row). Of course, one of skill in the art will recognize that in certain embodiments, the durometer of the material that makes up the spherical members 1008 in the middle row may be harder than the durometer of the material that makes up the spherical members 1008 in the outer rows. Additionally, in certain embodiments, the durometer of the material making up the spherical members 1008 of a particular row may fluctuate from row to row (i.e., hard, soft, hard, soft, hard or soft, hard, soft, hard, soft).

In yet another embodiment, the durometer of the material of a particular spherical member 1008 may fluctuate within a row. For example, with respect to the first row, in one embodiment, a first spherical member 1008m may have a relatively hard durometer, a second spherical member 1008n may have a relatively soft durometer, a third spherical member 1008o may have a relatively hard durometer, and a fourth spherical member 1008p may have a relatively soft durometer. In the example just presented the pattern of durometer's for the spherical members 1008 is repeating. However, one of skill in the art will recognize that in other embodiments, the hardness (durometer) of the spherical members 1008 may be random.

In another embodiment, rather than defining a particular type of spherical member 1008 by a durometer of the materials that make up the spherical members 1008, the types of spherical members 1008 may be defined by a size of the spherical members 1008. As discussed above, by varying a size of a particular spherical member 1008 with respect to the spherical members 1008 adjacent to that spherical member, the apparatus 1000 applies a varying amount of pressure to an area on a user's body. For example, in one embodiment, the spherical members in the third row (i.e., spherical members 1008h and 1008i) may have a smaller periphery than the spherical members 1008 in the second row (i.e., spherical members 1008j-1008l) and the spherical members 1008 in the fourth row (i.e., spherical members 1008e-1008g). In such an embodiment, when the apparatus is used in a horizontal position, the spherical members 1008 in the second row and the fourth row will hold a user at a higher position than the spherical members 1008 in the third row. This causes less pressure to be applied by the spherical members 1008 in the third row than the pressure applied by the spherical members 1008 in the second and fourth row. One of skill in the art will recognize other ways of increasing or decreasing pressure applied by a particular spherical member 1008 or row of spherical members 1008.

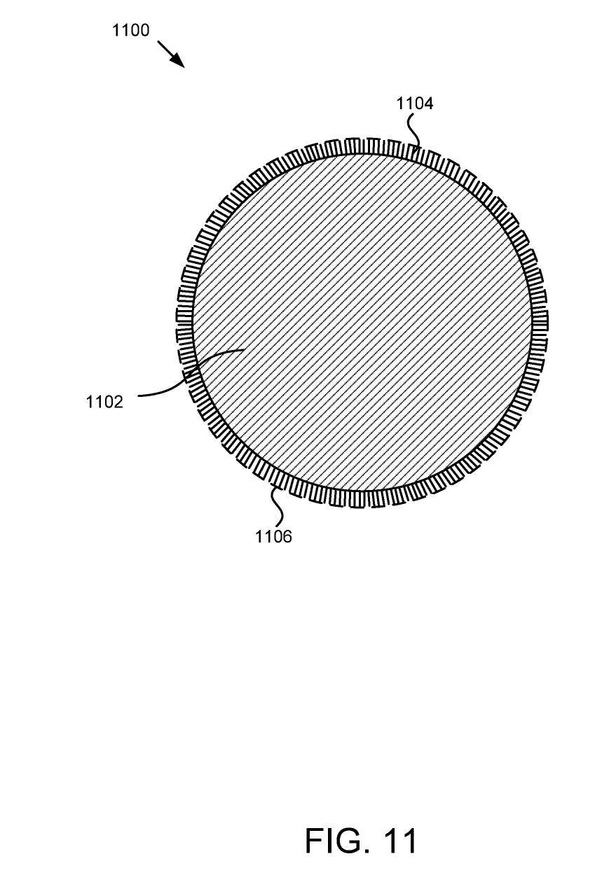

FIG. 11 depicts a cutaway view of one embodiment of a spherical member 1100. In certain embodiments, the spherical member 1100 includes a core material 1102 and a flocked outer coating 1104.

The core material 1102 of the spherical member 1100, in certain embodiments, is an ABS plastic material. In another embodiment, the core material 1102 of the spherical member 1100 is a polypropylene material. In yet another embodiment, the core material 1102 of the spherical member 1100 is a rubber material. One of skill in the art will recognize that that the core material 1102 of the spherical member 1100 may be made of other suitable materials and that ABS plastics, polypropylene plastics, and rubbers are given as an exemplary embodiment to facilitate the discussion of the present subject matter.

ABS plastics, polypropylene plastics, rubbers, etc. may all have differing durometer's. Accordingly, in certain embodiments, the durometer of a particular spherical member 1100 may be varied according to the material that makes up the core material 1102 of the spherical member 1100.

As discussed above, in certain embodiments, an apparatus for manipulating soft tissue such as apparatus 100, 500, and 1000, may include a plurality of different types of spherical members 1100. In certain embodiments, a particular type of spherical member 1100 may be defined by the material that makes up the core material 1102 of the spherical member 1100. For example, a first type of spherical member 1100 may include spherical members 1100 that have ABS plastic as the core material 1102. A second type of spherical member 1100 may include spherical members 1100 that have polypropylene as the core material 1102. A third type of spherical member 1100 may include spherical members 1100 that have rubber as the core material 1102. Other types of spherical members 1100 may have other materials that make up the core material 1102.

One of skill in the art will recognize that there are different types of ABS plastics, polypropylene plastics, rubbers, etc. As such, two or more types ABS plastic, polypropylene plastic, rubber, etc. may be the core material 1102 of two or more types of spherical members 1100. For example, a first type of spherical member 1100 may be made of a first type of rubber and a second type of spherical member 1100 may be made of a second type of rubber.

In certain embodiments, the spherical member 1100 may include a flocked outer coating 1104. Flocking is the process of depositing many small fiber particles (called flock) onto an article, in this case onto the spherical member 1100. Flocking essentially coats the spherical member 1100 with an outer surface of fiber particles such that the outer surface 1106 (as illustrated by dotted line) of the spherical member 1100 is made up of the flocking material. In one embodiment, the flocking material of the outer coating 1104 may be finely cut natural or synthetic materials. In an exemplary embodiment, the flocking material of the outer coating may be a nylon material.

To flock the spherical member 1100, in certain embodiments, the core material 1102 of the spherical member 1100 is first coated with an adhesive and the flocking material is applied to the adhesive. In one embodiment, the flocking material is given a negative electrical charge and the core material 1102 of the spherical member 1100 is grounded. In such an embodiment, the flocking material is attracted to the core material 1102 of the spherical member 1100 and adheres to the core material 1102 of the spherical member 1100 by virtue of the adhesive.

By flocking the spherical member 1100, the outer surface 1106 of the spherical member 1100 is the flocking material. Different flocking materials may be used to adjust the static coefficient of friction between the outer surface 1106 of the spherical member 1100 and the concave surface 118 (FIG. 1) of the spherical member receiving space 120 (FIG. 1). That is, in certain embodiments, by using a material having a low static coefficient of friction with the material that makes up the concave surface 118 of the spherical member receiving space 120, the spherical member 110 can easily rotate within the spherical member receiving space 120.

Additionally, different flocking materials may be used to provide differing durometer's to the spherical member 1100. A softer flocking material will provide a softer spherical member 1100. The flocking material may also enhance the aesthetics of the spherical member 1100 in terms of tactile sensation, color, appearance, etc.

The present subject matter may be embodied in other specific forms without departing from its spirit or essential characteristics. The described embodiments are to be considered in all respects only as illustrative and not restrictive. The scope of the subject matter is, therefore, indicated by the appended claims rather than by the foregoing description. All changes which come within the meaning and range of equivalency of the claims are to be embraced within their scope.

What is claimed is:

1. An apparatus for manipulating soft tissue, the apparatus comprising:
a support member;
a plurality of substantially circular voids disposed through the support member, each substantially circular void in alignment with a substantially hemispherical recess having a concave surface defining a spherical member receiving space;
a plurality of spherical members, each spherical member having an outer surface, wherein each spherical member is positioned within a respective spherical member receiving space defined by the substantially hemispherical recesses, each of the plurality of spherical members being rotatable within one of the spherical member receiving spaces in the plurality of hemispherical recesses about an infinite number of axes of rotation; and
wherein each concave surface of the substantially hemispherical recess is made from a first material and wherein the outer surface of each spherical member is made from a second material, the first material and the second material selected such that a static coefficient of friction between the first material and second material facilitates rotation of the spherical members within the spherical member receiving spaces.

2. The apparatus of claim 1, wherein a first outer reach plane tangential to an outermost point on a first spherical member in the plurality of spherical members is different from a second outer reach plane tangential to the outermost point on a second spherical member in the plurality of spherical members, the outer most points on the first and second spherical members comprising points on the first and second spherical members respectively that are the furthest away from the support member.

3. The apparatus of claim 1, wherein the support member comprises a first end disposed opposite a second end, wherein each of the plurality of spherical members are positioned between the first end and the second end, wherein, when the support member is positioned in a horizontal position, an outer reach plane tangential to an outermost point on a spherical member positioned adjacent to one of the first end and the second end is substantially lower than an outer reach plane tangential to an outermost point on a spherical member positioned within a central portion of the support member.

4. The apparatus of claim 1, wherein the support member comprises a first end disposed opposite a second end, wherein the plurality of spherical members are arranged in a first row, a second row, a third row, a fourth row, and a fifth row across the support member, the first row of spherical members positioned adjacent to the first end of the support member, the fifth row of spherical members positioned adjacent to the second end of the support member, the second row of spherical members and the fourth row of spherical members positioned between the first row of spherical members and the fifth row of spherical members, the third row of spherical members positioned between the second row of spherical members and the fourth row of spherical members, wherein, when the support member is positioned in a horizontal position, an outer reach plane tangential to an outermost point on spherical members positioned in the first row and the fifth row have an outermost reach away from the support member that is substantially lower than an outer reach plane tangential to an outermost point on spherical members positioned in the second row and the fourth row.

5. The apparatus of claim 4, wherein an outer reach plane tangential to an outermost point on spherical members positioned in the second row and fourth row is substantially lower than an outer reach plane tangential to an outermost point on spherical members positioned in the third row.

6. The apparatus of claim 1, wherein the support member comprises a first end disposed opposite a second end, the first end and the second end disposed along a common plane, wherein a central portion of the support member is positioned between the first end and the second end, the central portion disposed along a plane offset from the common plane.

7. The apparatus of claim 1, wherein the support member includes an articulated receiving surface contoured to receive a user's back.

8. The apparatus of claim 7, wherein the receiving surface is convex.

9. The apparatus of claim 7, wherein the receiving surface is concave.

10. The apparatus of claim 1, further comprising a base member and a plurality of cupping members, the base member supporting the plurality of cupping members, wherein each of the cupping members define the substantially hemispherical recess.

11. The apparatus of claim 10, wherein the base member includes a plurality of steps, each step supporting at least one of the plurality of cupping members.

12. The apparatus of claim 11, wherein the plurality of steps comprises a first step, a second step, a third step, a fourth step, and a fifth step, wherein the first step and the second step are positioned along a first plane, the third step and the fourth step are positioned along a second plane, and the fifth step is positioned along a third plane.

13. The apparatus of claim 1, wherein each of the plurality of spherical members rotate independent of one another.

14. The apparatus of claim 1, further comprising a membrane covering each spherical member, the membrane comprising the second material.

15. The apparatus of claim 1, wherein the plurality of spherical members comprises at least two types of spherical members, wherein each spherical member of a first type of spherical members comprises a spherical member comprising a material having a first durometer and wherein each spherical member of at least one other type of spherical members comprises a spherical member comprising a material having a second durometer, the first durometer comprising a durometer less than the second durometer.

16. The apparatus of claim 1, wherein the plurality of spherical members comprises at least two types of spherical members, wherein a periphery of each spherical member of a first type of spherical members is larger than a periphery of each spherical member of a second type of spherical members.

17. The apparatus of claim 1, wherein the plurality of spherical members comprises at least two types of spherical members, wherein each spherical member of a first type of spherical members is interchangeable with a spherical member of at least one other type of spherical members.

18. An apparatus for manipulating soft tissue, the apparatus comprising:
a support member;
a plurality of substantially circular voids disposed through the support member, each substantially circular void in alignment with a substantially hemispherical recess having a concave surface defining a spherical member receiving space;
at least two types of spherical members, wherein each spherical member of a first type of spherical members comprises a spherical member comprising a material having a first durometer and wherein each spherical member of at least one other type of spherical members comprises a spherical member comprising a material having a second durometer, the first durometer comprising a durometer less than the second durometer; and
wherein each spherical member is positioned within a respective spherical member receiving space defined by the substantially hemispherical recess, each of the plurality of spherical members being rotatable within one of the spherical member receiving spaces in the plurality of hemispherical recesses about an infinite number of axes of rotation.

19. The apparatus of claim 18, wherein each spherical member of the first type of spherical members is interchangeable with a spherical member of the at least one other type of spherical members.

20. The apparatus of claim 18, wherein the support member includes an articulated receiving surface contoured to receive a user's back.

21. An apparatus for manipulating soft tissue, the apparatus comprising:
a support member;
a plurality of substantially circular voids disposed through the support member, each substantially circular void in alignment with a substantially hemispherical recess having a concave surface defining a spherical member receiving space; and
at least two types of spherical members, wherein each spherical member of a first type of spherical members comprises a spherical member comprising a material having a first durometer and wherein each spherical member of at least one other type of spherical members comprises a spherical member comprising a material having a second durometer, the first durometer comprising a durometer less than the second durometer;
wherein each spherical member of the first type of spherical members is interchangeable with a spherical member of the at least one other type of spherical members, each spherical member is positioned within a respective spherical member receiving space and rotatable within the spherical member receiving space about an infinite number of axes of rotation.
